(19) United States
(12) Patent Application Publication
(10) Pub. No.: US 2019/0190074 A1
(43) Pub. Date: Jun. 20, 2019

(54) NONAQUEOUS ELECTROLYTE SECONDARY BATTERY

(71) Applicant: Sumitomo Chemical Company, Limited, Tokyo (JP)

(72) Inventors: Kosuke KURAKANE, Osaka (JP); Toshihiko OGATA, Osaka (JP); Chikae YOSHIMARU, Osaka (JP); Chikara MURAKAMI, Osaka (JP)

(21) Appl. No.: 16/224,767

(22) Filed: Dec. 18, 2018

(30) Foreign Application Priority Data
Dec. 19, 2017 (JP) 2017-243293

(51) Int. Cl. H01M 10/0585; H01M 10/48; H01M 10/0525; H01M 2/16; H01M 4/131; H01M 4/133; H01M 4/48; H01M 4/583

(52) U.S. Cl. CPC H01M 10/0585; H01M 10/48; H01M 10/0525; H01M 4/583; H01M 4/131; H01M 4/133; H01M 4/48; H01M 2/16

(57) ABSTRACT

A nonaqueous electrolyte secondary battery satisfies the following requirements: (a) in a PVDF-based resin contained in a porous layer, a content of an α-form PVDF-based resin is above 35.0 mol % with respect to 100 mol % of a total content of α- and β-form PVDF-based resins; (b) a porous film has a temperature rise ending time of 2.9-5.7 seconds·m²/g with respect to a resin content per area, wherein the porous film is impregnated with N-methylpyrrolidone containing 3% by weight of water and is irradiated with a 2455 MHz 1800 W microwave; (c) a positive electrode plate, before peeling of its active material layer has more than 130 bends in a folding endurance test with a 1 N load and a 45° bending angle; and (d) a negative electrode plate, before peeling of its active material layer occurs has more than 1650 bends in the folding endurance test.

This Nonprovisional application claims priority under 35 U.S.C. § 119 on Patent Application No. 2017-243293 filed in Japan on Dec. 19, 2017, the entire contents of which are hereby incorporated by reference.

### TECHNICAL FIELD

The present invention relates to a nonaqueous electrolyte secondary battery.

### BACKGROUND ART

Nonaqueous electrolyte secondary batteries, particularly lithium-ion secondary batteries, have a high energy density, and are therefore in wide use as batteries for personal computers, mobile telephones, portable information terminals, and the like. Such nonaqueous electrolyte secondary batteries have recently been developed as on-vehicle batteries.

For example, Patent Literature 1 discloses a nonaqueous electrolyte secondary battery which includes a separator that has a temperature rise ending time falling within a specific range, in a case where the separator is irradiated with a microwave.

### CITATION LIST

### Patent Literature

[Patent Literature 1] Japanese Patent Application Publication, Tokukai, No. 2017-103042 (published on Jun. 8, 2017)

### SUMMARY OF INVENTION

### Technical Problem

However, the foregoing nonaqueous electrolyte secondary battery has room for improvement in regard to a capacity maintenance rate in the 100th charge-discharge cycle.

An object of an aspect of the present invention is to realize a nonaqueous electrolyte secondary battery which is excellent in capacity maintenance rate in the 100th charge-discharge cycle.

### Solution to Problem

A nonaqueous electrolyte secondary battery in accordance with an aspect of the present invention is a nonaqueous electrolyte secondary battery including: a nonaqueous electrolyte secondary battery separator including a polyolefin porous film; a porous layer containing a polyvinylidene fluoride-based resin; a positive electrode plate, the number of bends of the positive electrode plate being not less than 130, the number of bends indicating how many times the positive electrode plate is bent before peeling of a positive electrode active material layer occurs in a folding endurance test according to an MIT tester method specified in JIS P 8115 (1994), the folding endurance test being carried out under conditions of a load of 1 N and a bending angle of 45°; and a negative electrode plate, the number of bends of the negative electrode plate being not less than 1650, the number of bends indicating how many times the negative electrode plate is bent before peeling of a negative electrode active material layer occurs in the folding endurance test, the polyolefin porous film having a temperature rise ending time of 2.9 seconds·m²/g to 5.7 seconds·m²/g with respect to a resin content per unit area, in a case where the polyolefin porous film is impregnated with N-methylpyrrolidone containing 3% by weight of water and is irradiated with a microwave having a frequency of 2455 MHz and an output of 1800 W, the porous layer being provided between the nonaqueous electrolyte secondary battery separator and at least one of the positive electrode plate and the negative electrode plate, the polyvinylidene fluoride-based resin contained in the porous layer containing an α-form polyvinylidene fluoride-based resin and a β-form polyvinylidene fluoride-based resin, a content of the α-form polyvinylidene fluoride-based resin being not less than 35.0 mol % with respect to 100 mol % of a total content of the α-form polyvinylidene fluoride-based resin and the β-form polyvinylidene fluoride-based resin in the polyvinylidene fluoride-based resin, the content of the α-form polyvinylidene fluoride-based resin being calculated by (a) waveform separation of (α/2) observed at around −78 ppm in a ¹⁹F-NMR spectrum obtained from the porous layer and (b) waveform separation of {(α/2)+β} observed at around −95 ppm in the ¹⁹F-NMR spectrum obtained from the porous layer.

The nonaqueous electrolyte secondary battery in accordance with Aspect 2 of the present invention is arranged such that in the above Aspect 1, the positive electrode plate contains a transition metal oxide.

The nonaqueous electrolyte secondary battery in accordance with Aspect 3 of the present invention is arranged such that in the above Aspect 1 or 2, the negative electrode plate contains graphite.

The nonaqueous electrolyte secondary battery in accordance with Aspect 4 of the present invention is arranged so as to, in any one of the above Aspects 1 to 3, further include: another porous layer which is provided between the nonaqueous electrolyte secondary battery separator and at least one of the positive electrode plate and the negative electrode plate.

The nonaqueous electrolyte secondary battery in accordance with Aspect 5 of the present invention is arranged such that in any one of the above Aspects 1 to 4, the another porous layer contains at least one kind of resin selected from the group consisting of polyolefins, (meth)acrylate-based resins, fluorine-containing resins (excluding the polyvinylidene fluoride-based resin), polyamide-based resins, polyester-based resins, and water-soluble polymers.

The nonaqueous electrolyte secondary battery in accordance with Aspect 6 of the present invention is arranged such that in Aspect 5, the polyamide-based resins are aramid resins.

### Advantageous Effects of Invention

According to an aspect of the present invention, it is possible to realize a nonaqueous electrolyte secondary battery which is excellent in capacity maintenance rate in the 100th charge-discharge cycle.

### BRIEF DESCRIPTION OF DRAWINGS

FIG. 1 is a diagram schematically illustrating an MIT tester.

### DESCRIPTION OF EMBODIMENTS

The following description will discuss an embodiment of the present invention. Note, however, that the present invention is not limited to the embodiment. The present invention is not limited to arrangements described below, but may be altered in various ways by a skilled person within the scope of the claims. Any embodiment based on a proper combination of technical means disclosed in different embodiments is also encompassed in the technical scope of the present invention. Note that a numerical expression “A to B” herein means “not less than A and not more than B” unless otherwise stated.

A nonaqueous electrolyte secondary battery in accordance with an embodiment of the present invention is a nonaqueous electrolyte secondary battery including: a separator for a nonaqueous electrolyte secondary battery (hereinafter, also referred to as a “nonaqueous electrolyte secondary battery separator” or a “separator”) including a polyolefin porous film; a porous layer containing a polyvinylidene fluoride-based resin (hereinafter, also referred to as a “PVDF-based resin”); a positive electrode plate, the number of bends of the positive electrode plate being not less than 130, the number of bends indicating how many times the positive electrode plate is bent before peeling of a positive electrode active material layer occurs in a folding endurance test according to an MIT tester method specified in JIS P 8115 (1994), the folding endurance test being carried out under conditions of a load of 1 N and a bending angle of 45°; and a negative electrode plate, the number of bends of the negative electrode plate being not less than 1650, the number of bends indicating how many times the negative electrode plate is bent before peeling of a negative electrode active material layer occurs in the folding endurance test, the polyolefin porous film having a temperature rise ending time of 2.9 seconds·m²/g to 5.7 seconds·m²/g with respect to a resin content per unit area, in a case where the polyolefin porous film is impregnated with N-methylpyrrolidone containing 3% by weight of water and is irradiated with a microwave having a frequency of 2455 MHz and an output of 1800 W, the porous layer being provided between the nonaqueous electrolyte secondary battery separator and at least one of the positive electrode plate and the negative electrode plate, the polyvinylidene fluoride-based resin contained in the porous layer containing an α-form polyvinylidene fluoride-based resin and a β-form polyvinylidene fluoride-based resin, a content of the α-form polyvinylidene fluoride-based resin being not less than 35.0 mol % with respect to 100 mol % of a total content of the α-form polyvinylidene fluoride-based resin and the β-form polyvinylidene fluoride-based resin in the polyvinylidene fluoride-based resin, the content of the α-form polyvinylidene fluoride-based resin being calculated by (a) waveform separation of (α/2) observed at around −78 ppm in a ¹⁹F-NMR spectrum obtained from the porous layer and (b) waveform separation of {(α/2)+β} observed at around −95 ppm in the ¹⁹F-NMR spectrum obtained from the porous layer.

<Nonaqueous Electrolyte Secondary Battery Separator>

A nonaqueous electrolyte secondary battery separator in accordance with an embodiment of the present invention includes a polyolefin porous film. Note that, in the following description, the “polyolefin porous film” may be also referred to as a “porous film”.

The porous film can serve as the nonaqueous electrolyte secondary battery separator by itself. Alternatively, the porous film can be a base material of a laminated separator for a nonaqueous electrolyte secondary battery (hereinafter referred to as a “nonaqueous electrolyte secondary battery laminated separator”) in which a porous layer (described later) is provided. The porous film contains a polyolefin-based resin as a main component, and has therein many pores connected to one another so that a gas and/or a liquid can pass through the porous film from one surface to the other.

According to the nonaqueous electrolyte secondary battery separator in accordance with an embodiment of the present invention, a porous layer containing a polyvinylidene fluoride-based resin (described later) can be disposed on at least one surface of the nonaqueous electrolyte secondary battery separator. In this case, a laminated body obtained by disposing the porous layer on at least one surface of the nonaqueous electrolyte secondary battery separator is herein referred to as a “nonaqueous electrolyte secondary battery laminated separator” or a “laminated separator”. The nonaqueous electrolyte secondary battery separator in accordance with an embodiment of the present invention can further include any other layer(s) such as an adhesive layer, a heat-resistant layer, and/or a protective layer, in addition to the polyolefin porous film.

The porous layer is provided, as a constituent member of a nonaqueous electrolyte secondary battery, between the nonaqueous electrolyte secondary battery separator and at least one of a positive electrode plate and a negative electrode plate. The porous layer can be provided on one surface or each of both surfaces of the nonaqueous electrolyte secondary battery separator. Alternatively, the porous layer can be provided on at least one of a positive electrode active material layer of the positive electrode plate and a negative electrode active material layer of the negative electrode plate. Alternatively, the porous layer can be provided between the nonaqueous electrolyte secondary battery separator and at least one of the positive electrode plate and the negative electrode plate so as to be in contact with the nonaqueous electrolyte secondary battery separator and the positive electrode plate or the negative electrode plate.

(Polyolefin Porous Film)

The porous film contains polyolefin in a proportion of not less than 50% by volume, preferably not less than 90% by volume, and more preferably not less than 95% by volume, with respect to a whole of the porous film. The polyolefin more preferably contains a high molecular weight component having a weight-average molecular weight of 5×10⁵ to 15×10⁶. In particular, the polyolefin more preferably contains a high molecular weight component having a weight-average molecular weight of not less than 1,000,000, because strength of the nonaqueous electrolyte secondary battery separator is improved.

Specific examples of the polyolefin, which is a thermoplastic resin, include homopolymers and copolymers which are each obtained by polymerizing a monomer(s) such as ethylene, propylene, 1-butene, 4-methyl-1-pentene, and/or 1-hexene. Specifically, examples of such homopolymers include polyethylene, polypropylene, and polybutene. Meanwhile, examples of such copolymers include an ethylene-propylene copolymer.

Among the above polyolefins, polyethylene is more preferable because it is possible to prevent (shut down) a flow of an excessively large electric current at a lower temperature. Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these polyethylenes, ultra-high molecular weight polyethylene having a weight-average molecular weight of not less than 1,000,000 is still more preferable.

The porous film has a thickness of preferably 4 μm to 40 μm, more preferably 5 μm to 30 μm, and still more preferably 6 μm to 15 μm.

The porous film has a weight per unit area which weight should be set as appropriate in view of strength, a thickness, a weight, and handleability of the porous film. Note, however, that the weight per unit area of the porous film is preferably 4 g/m² to 20 g/m², more preferably 4 g/m² to 12 g/m², and still more preferably 5 g/m² to 10 g/m², so as to allow the nonaqueous electrolyte secondary battery to have a higher weight energy density and a higher volume energy density.

The porous film has an air permeability of preferably 30 sec/100 mL to 500 sec/100 mL, and more preferably 50 sec/100 mL to 300 sec/100 mL, in terms of Gurley values. The porous film having the above air permeability can achieve sufficient ion permeability.

The porous film has a porosity of preferably 20% by volume to 80% by volume, and more preferably 30% by volume to 75% by volume, so as to (i) retain an electrolyte in a larger amount and (ii) obtain a function of reliably preventing (shutting down) a flow of an excessively large electric current at a lower temperature. Further, the pores in the porous film each have a pore diameter of preferably not more than 0.3 μm, and more preferably not more than 0.14 μm so that the porous film can achieve sufficient ion permeability and particles are prevented from entering the positive electrode plate and the negative electrode plate.

The porous film in accordance with an embodiment of the present invention can be produced by, for example, a method as described below.

That is, the porous film can be obtained by a method including the steps of (1) obtaining a polyolefin resin composition by kneading ultra-high molecular weight polyethylene, low molecular weight polyolefin having a weight-average molecular weight of not more than 10,000, and a pore forming agent such as calcium carbonate or a plasticizer, (2) forming a sheet by rolling the polyolefin resin composition with use of a reduction roller (rolling step), (3) removing the pore forming agent from the sheet obtained in the step (2), and (4) obtaining a porous film by stretching the sheet obtained in the step (3).

Here, a structure of the pores in the porous film (namely, a capillary force in the pores, an area of walls of the pores, and stress remaining in the porous film) is affected by (i) a strain rate during stretching in the step (4) and (ii) a temperature, during a heat fixation treatment (annealing treatment) after the stretching, per unit thickness of a stretched film (a heat fixation temperature per unit thickness of the stretched film). Therefore, by adjusting the strain rate and the heat fixation temperature per unit thickness of the stretched film, it is possible to control the structure of the pores in the porous film, and accordingly possible to control a temperature rise ending time with respect to a resin content per unit area.

Specifically, the porous film which constitutes the nonaqueous electrolyte secondary battery in accordance with an embodiment of the present invention tends to be obtained in a case where the strain rate and the heat fixation temperature per unit thickness of the stretched film are adjusted to fall within a range that is defined by a triangle having three vertices at (500% per minute, 1.5° C./μm), (900% per minute, 14.0° C./μm), and (2500% per minute, 11.0° C./μm), respectively, on a graph in which an x-axis shows the strain rate and a y-axis shows the heat fixation temperature per unit thickness of the stretched film. The strain rate and the heat fixation temperature per unit thickness of the stretched film are preferably adjusted to fall within a range that is defined by a triangle having three vertices at (600% per minute, 5.0° C./μm), (900% per minute, 12.5° C./μm), and (2500% per minute, 11.0° C./μm), respectively, on the above graph.

A porous film which contains N-methylpyrrolidone containing water and which is irradiated with a microwave generates heat by vibrational energy of the water. The heat thus generated is transferred to a resin which is contained in the porous film and with which the N-methylpyrrolidone containing water is in contact. A temperature rise ends at a time when equilibrium is reached between (i) a rate of heat generation and (ii) a rate of cooling caused by transfer of the heat to the resin. This indicates that a time period which elapses before the temperature rise ends (temperature rise ending time) is related to a degree of contact between (i) a liquid contained in the porous film (in this example, the N-methylpyrrolidone containing water) and (ii) the resin contained in the porous film. The degree of contact between the liquid contained in the porous film and the resin contained in the porous film is closely related to a capillary force in pores in the porous film and an area of walls of the pores. Thus, it is possible to use the temperature rise ending time to evaluate a structure of the pores in the porous film (namely, the capillary force in the pores and the area of the walls of the pores). Specifically, a shorter temperature rise ending time indicates that the capillary force in the pores is greater and that the area of the walls of the pores is larger.

The degree of contact between the liquid contained in the porous film and the resin contained in the porous film is presumably larger in a case where the liquid more easily moves through the pores in the porous film. Therefore, it is possible to use the temperature rise ending time to evaluate a capability to supply an electrolyte from the porous film to electrodes. Specifically, a shorter temperature rise ending time indicates that the capability to supply the electrolyte from the porous film to the electrodes is higher.

The polyolefin porous film in accordance with an embodiment of the present invention has a temperature rise ending time of 2.9 seconds·m²/g to 5.7 seconds·m²/g, preferably 2.9 seconds·m²/g to 5.3 seconds·m²/g, with respect to the resin content per unit area, in a case where the polyolefin porous film is impregnated with N-methylpyrrolidone containing 3% by weight of water and is irradiated with a microwave having a frequency of 2455 MHz and an output of 1800 W.

Note that a temperature of the porous film which is impregnated with the N-methylpyrrolidone containing 3% by weight of water is 29° C.±1° C. at a time when irradiation with the microwave is started. Note also that the temperature rise ending time is measured under atmospheric air with use of a device in which a temperature is set at an ordinary temperature (for example, 30° C.±3° C.).

In a case where the temperature rise ending time with respect to the resin content per unit area is less than 2.9 seconds·m²/g, the capillary force in the pores in the porous film and the area of the walls of the pores is excessively large. This results in an increase in stress caused on the walls of the pores when the electrolyte moves through the pores during a charge-discharge cycle and/or during use of the battery with a large electric current. This in turn blocks the pores, with the result of a deterioration in battery output characteristic.

In a case where the temperature rise ending time with respect to the resin content per unit area is more than 5.7 seconds·m²/g, a liquid moves less easily through the pores in the porous film. Furthermore, in a case where the porous film is used as the nonaqueous electrolyte secondary battery separator, the electrolyte moves more slowly near an interface between the porous film and an electrode, with the result of a deterioration in rate characteristic of the battery. In addition, in a case where the battery is charged and discharged repeatedly, the electrolyte is more likely to be depleted locally at the interface between the separator and the electrode or inside the porous film. This consequently causes an increase in internal resistance of the battery, with the result of a deterioration in rate characteristic of the nonaqueous electrolyte secondary battery after a charge-discharge cycle.

In contrast, by causing the temperature rise ending time with respect to the resin content per unit area to be 2.9 seconds·m²/g to 5.7 seconds·m²/g, it is possible to (i) achieve an excellent initial rate characteristic, (ii) prevent a deterioration in rate characteristic after a charge-discharge cycle, and (iii) improve a capacity maintenance rate in the 100th charge-discharge cycle, as demonstrated in Examples below.

Note that, in a case where the porous layer and/or the any other layer(s) is(are) disposed on the porous film, physical property values of the porous film can be measured by removing the porous layer and/or the any other layer(s) from the laminated body including the porous film and the porous layer and/or the any other layer(s). The porous layer and/or the any other layer(s) can be removed from the laminated body by, for example, a method in which a resin(s) constituting the porous layer and/or the any other layer(s) is(are) dissolved with use of a solvent such as N-methylpyrrolidone or acetone for removal.

(Porous Layer)

In an embodiment of the present invention, the porous layer is provided, as a constituent member of the nonaqueous electrolyte secondary battery, between the nonaqueous electrolyte secondary battery separator and at least one of the positive electrode plate and the negative electrode plate. The porous layer can be provided on one surface or each of both surfaces of the nonaqueous electrolyte secondary battery separator. Alternatively, the porous layer can be provided on at least one of the positive electrode active material layer of the positive electrode plate and the negative electrode active material layer of the negative electrode plate. Alternatively, the porous layer can be provided between the nonaqueous electrolyte secondary battery separator and at least one of the positive electrode plate and the negative electrode plate so as to be in contact with the nonaqueous electrolyte secondary battery separator and the positive electrode plate or the negative electrode plate. The porous layer can be provided so as to form one layer or two or more layers between the nonaqueous electrolyte secondary battery separator and at least one of the positive electrode plate and the negative electrode plate.

The porous layer is preferably an insulating porous layer containing a resin.

A resin which can be contained in the porous layer is preferably a resin that is insoluble in the electrolyte of the battery and that is electrochemically stable when the battery is in normal use. In a case where the porous layer is disposed on one surface of the porous film, the porous layer is disposed preferably on a surface of the porous film which surface faces the positive electrode plate of the nonaqueous electrolyte secondary battery, more preferably on a surface of the porous film which surface is to be in contact with the positive electrode plate.

The porous layer in accordance with an embodiment of the present invention contains a PVDF-based resin which contains a PVDF-based resin having crystal form α (hereinafter, referred to as an “α-form PVDF-based resin”) and a PVDF-based resin having crystal form β (hereinafter, referred to as a “β-form PVDF-based resin”). The PVDF-based resin contains the α-form PVDF-based resin in a content of not less than 35.0 mol % with respect to 100 mol % of a total content of the α-form PVDF-based resin and the β-form PVDF-based resin in the PVDF-based resin.

The content of the α-form PVDF-based resin is calculated by (a) waveform separation of (α/2) observed at around −78 ppm in a ¹⁹F-NMR spectrum obtained from the porous layer and (b) waveform separation of {(α/2)+β} observed at around −95 ppm in the ¹⁹F-NMR spectrum obtained from the porous layer.

The porous layer has therein many pores connected to one another so that a gas and/or a liquid can pass through the porous layer from one surface to the other. Further, in a case where the porous layer in accordance with an embodiment of the present invention is used as a constituent member of the nonaqueous electrolyte secondary battery laminated separator, the porous layer can be a layer which, as an outermost layer of the separator, comes in contact with an electrode.

Examples of the PVDF-based resin include: homopolymers of vinylidene fluoride; copolymers of vinylidene fluoride and any other monomer(s) polymerizable with vinylidene fluoride; and mixtures of the above polymers. Examples of the any other monomer(s) polymerizable with vinylidene fluoride include hexafluoropropylene, tetrafluoroethylene, trifluoroethylene, trichloroethylene, and vinyl fluoride. It is possible to use one kind of monomer or two or more kinds of monomers selected from above monomers. The PVDF-based resin can be synthesized through emulsion polymerization or suspension polymerization.

The PVDF-based resin contains, as its constitutional unit, vinylidene fluoride in a proportion of normally not less than 85 mol %, preferably not less than 90 mol %, more preferably not less than 95 mol %, and further preferably not less than 98 mol %. The PVDF-based resin containing vinylidene fluoride in a proportion of not less than 85 mol % is more likely to allow the porous layer to have (i) mechanical strength against pressure during battery production and (ii) heat resistance against heat during the battery production.

The porous layer can also preferably contain two kinds of PVDF-based resins (that is, a first resin and a second resin below) that differ from each other in terms of, for example, a hexafluoropropylene content.

First resin: (i) a vinylidene fluoride-hexafluoropropylene copolymer containing hexafluoropropylene in a proportion of more than 0 mol % and not more than 1.5 mol % or (ii) a vinylidene fluoride homopolymer.

Second resin: a vinylidene fluoride-hexafluoropropylene copolymer containing hexafluoropropylene in a proportion of more than 1.5 mol %.

The porous layer containing the two kinds of PVDF-based resins adheres better to an electrode than the porous layer not containing one of the two kinds of PVDF-based resins. Further, the porous layer containing the two kinds of PVDF-based resins adheres better to another layer (for example, a layer of the porous film) included in the nonaqueous electrolyte secondary battery separator than the porous layer not containing one of the two kinds of PVDF-based resins. Accordingly, the porous layer containing the two kinds of PVDF-based resins causes an increase in peel force which is required to peel the porous layer from the another layer, as compared to the porous layer not containing one of the two kinds of PVDF-based resins. The first resin and the second resin are preferably at a mass ratio (first resin:second resin) of 15:85 to 85:15.

The weight-average molecular weight of the PVDF-based resin is preferably 200,000 to 3,000,000, more preferably 200,000 to 2,000,000, still more preferably 500,000 to 1,500,000. The PVDF-based resin having a weight-average molecular weight of not less than 200,000 tends to allow the porous layer and the electrode to sufficiently adhere to each other. On the other hand, the PVDF-based resin having a weight-average molecular weight of not more than 3,000,000 tends to allow the porous layer to have excellent formability.

The porous layer in accordance with an embodiment of the present invention can contain, as a resin other than the PVDF-based resin, for example, a styrene-butadiene copolymer; any of homopolymers and copolymers of vinyl nitriles such as acrylonitrile and methacrylonitrile; and polyethers such as polyethylene oxide and polypropylene oxide.

The porous layer in accordance with an embodiment of the present invention can contain a filler. The filler can be an inorganic filler or an organic filler. The filler is contained in a proportion of preferably not less than 1% by mass and not more than 99% by mass, and more preferably not less than 10% by mass and not more than 98% by mass, with respect to a total amount of the PVDF-based resin and the filler. A lower limit of the proportion of the filler can be not less than 50% by mass, not less than 70% by mass, or not less than 90% by mass. The filler, such as an organic filler or an inorganic filler, can be a conventionally known filler.

The porous layer has an average thickness of preferably 0.5 μm to 10 μm per layer, and more preferably 1 μm to 5 μm per layer in order to ensure adhesion of the porous layer to the electrode and a high energy density.

In a case where the porous layer has a thickness of not less than 0.5 μm per layer, it is possible to sufficiently prevent an internal short circuit caused by, for example, breakage of the nonaqueous electrolyte secondary battery. Furthermore, the porous layer retains the electrolyte in a sufficient amount.

On the other hand, in a case where the porous layer has a thickness of more than 10 μm per layer, the porous layer has an increased resistance to permeation of lithium ions in the nonaqueous electrolyte secondary battery. Thus, repeating charge-discharge cycles will degrade the positive electrode plate of the nonaqueous electrolyte secondary battery. This leads to a deterioration in rate characteristic and a deterioration in cycle characteristic. Further, such a porous layer causes an increase in distance between the positive electrode plate and the negative electrode plate. This leads to a decrease in internal volume efficiency of the nonaqueous electrolyte secondary battery.

The porous layer in accordance with an embodiment of the present invention is preferably provided between the nonaqueous electrolyte secondary battery separator and the positive electrode active material layer which is included in the positive electrode plate. In the following description of physical properties of the porous layer, the physical properties of the porous layer means at least physical properties of the porous layer which is provided, in a resultant nonaqueous electrolyte secondary battery, between the nonaqueous electrolyte secondary battery separator and the positive electrode active material layer which is included in the positive electrode plate.

The porous layer has a weight per unit area (per layer) which weight should be set as appropriate in view of strength, a thickness, a weight, and handleability of the porous layer. A coating amount (weight per unit area) of the porous layer is preferably 0.5 g/m² to 20 g/m² per layer, and more preferably 0.5 g/m² to 10 g/m² per layer.

The porous layer having a weight per unit area falling within the above numerical range allows the nonaqueous electrolyte secondary battery including the porous layer to have a higher weight energy density and a higher volume energy density. In a case where the weight per unit area of the porous layer is beyond the above range, the nonaqueous electrolyte secondary battery including the porous layer will be heavy.

The porous layer has a porosity of preferably 20% by volume to 90% by volume, and more preferably 30% by volume to 80% by volume, in order to achieve sufficient ion permeability. The pores in the porous layer each have a pore diameter of preferably not more than 1.0 μm, and more preferably not more than 0.5 μm. In a case where the pores each have such a pore diameter, the nonaqueous electrolyte secondary battery which includes the nonaqueous electrolyte secondary battery laminated separator including the porous layer can achieve sufficient ion permeability.

The nonaqueous electrolyte secondary battery laminated separator has an air permeability of preferably 30 sec/100 mL to 1000 sec/100 mL, and more preferably 50 sec/100 mL to 800 sec/100 mL, in terms of Gurley values. The nonaqueous electrolyte secondary battery laminated separator having such an air permeability can achieve sufficient ion permeability in the nonaqueous electrolyte secondary battery.

In a case where the air permeability is below the above range, the nonaqueous electrolyte secondary battery laminated separator has a high porosity and thus has a coarse laminated structure. This may ultimately cause a decrease in strength of the nonaqueous electrolyte secondary battery laminated separator and cause the nonaqueous electrolyte secondary battery laminated separator to have insufficient shape stability particularly at high temperatures. On the other hand, in a case where the air permeability is beyond the above range, the nonaqueous electrolyte secondary battery laminated separator may not be able to achieve sufficient ion permeability. This may cause a deterioration in battery characteristic of the nonaqueous electrolyte secondary battery.

(Crystal Forms of PVDF-Based Resin)

The PVDF-based resin contained in the porous layer used in an embodiment of the present invention contains the α-form PVDF-based resin in a content of not less than 35.0 mol %, preferably not less than 37.0 mol %, more preferably not less than 40.0 mol %, and still more preferably not less than 44.0 mol % with respect to 100 mol % of the total content of the α-form PVDF-based resin and the β-form PVDF-based resin in the PVDF-based resin. Further, the α-form PVDF-based resin is contained preferably in a content of not more than 90.0 mol %. The porous layer which contains the PVDF-based resin containing the α-form PVDF-based resin in a content falling within the above range can be suitably used as a constituent member of the nonaqueous electrolyte secondary battery, which is excellent in capacity maintenance rate in the 100th charge-discharge cycle, particularly as a constituent member of the laminated separator for such a nonaqueous secondary battery or as a constituent member of the electrode for such a nonaqueous electrolyte secondary battery.

In a case where a nonaqueous electrolyte secondary battery is repeatedly charged and discharged, a temperature inside the nonaqueous electrolyte secondary battery rises due to heat generated during charge and discharge. A melting point of the α-form PVDF-based resin is higher than that of the β-form PVDF-based resin. Accordingly, plastic deformation due to the heat less occurs in the α-form PVDF-based resin than in the β-form PVDF-based resin.

In the porous layer in accordance with an embodiment of the present invention, a proportion of the α-form PVDF-based resin contained in the PVDF-based resin constituting the porous layer is arranged so as to be not lower than a certain level. This makes it possible to reduce deformation of an internal structure of the porous layer, blockage of the pores, and/or the like each caused by deformation of the PVDF-based resin due to heat generated during repetition of charge and discharge, and consequently makes it possible to prevent a deterioration in battery performance.

The α-form PVDF-based resin is characterized by being made of a polymer containing a PVDF skeleton having the following conformation:

(TGTG̅-TYPE CONFORMATION) [Math. 1]

The conformation includes two or more constituent conformations chained consecutively, each of which constituent conformations is arranged such that, with respect to a fluorine atom (or a hydrogen atom) bonded to one carbon atom in a main chain of a molecular chain of the PVDF skeleton, (i) a hydrogen atom (or a fluorine atom) bonded to a neighboring carbon atom in the main chain is in a trans position, which neighboring carbon atom is adjacent to the one carbon atom on one side of the one carbon atom, and (ii) a hydrogen atom (or a fluorine atom) bonded to another neighboring carbon atom in the main chain is in a gauche position (positioned at an angle of 60°), which another neighboring carbon atom is adjacent to the one carbon atom on the other (opposite) side of the one carbon atom. Further, the molecular chain is of the following type:

T G T G̅ [Math. 2]

wherein respective dipole moments of C—F₂ and C—H₂ bonds each have a component perpendicular to the molecular chain and a component parallel to the molecular chain.

In a ¹⁹F-NMR spectrum of the α-form PVDF-based resin, characteristic peaks appear at around −95 ppm and at around −78 ppm.

The β-form PVDF-based resin is characterized by being made of a polymer containing a PVDF skeleton in which (i) a fluorine atom and a hydrogen atom are bonded respectively to carbon atoms adjacent to each other in a main chain of a molecular chain of the PVDF skeleton and (ii) the fluorine atom and the hydrogen atom are arranged in a trans conformation (TT-type conformation). In other words, the β-form PVDF-based resin is characterized by being made of a polymer containing a PVDF skeleton in which a fluorine atom and a hydrogen atom, bonded respectively to adjacent carbon atoms forming a carbon-carbon bond in a main chain, are positioned oppositely at an angle of 180 degrees when viewed in a direction of that carbon-carbon bond.

The β-form PVDF-based resin can be arranged such that the PVDF skeleton has a TT-type conformation in its entirety. Alternatively, the β-form PVDF-based resin can be arranged such that a portion of the PVDF skeleton has the TT-type conformation and that the PVDF skeleton has a molecular chain of the TT-type conformation in at least four consecutive PVDF monomer units. In either case, in the TT-type conformation, (i) the carbon-carbon bond, which constitutes a TT backbone, has a planar zigzag structure, and (ii) respective dipole moments of C—F₂ and C—H₂ bonds each have a component perpendicular to the molecular chain.

In a ¹⁹F-NMR spectrum of the β-form PVDF-based resin, a characteristic peak appears at around −95 ppm.

(Method of Calculating Content Ratios of α-Form PVDF-Based Resin and β-Form PVDF-Based Resin in PVDF-Based Resin)

A content ratio of the α-form PVDF-based resin and a content ratio of the β-form PVDF-based resin are ratios with respect to 100 mol % of the total content of the α-form PVDF-based resin and the β-form PVDF-based resin in the porous layer in accordance with an embodiment of the present invention. The content ratio of the α-form PVDF-based resin and the content ratio of the β-form PVDF-based resin can be calculated from a ¹⁹F-NMR spectrum obtained from the porous layer. Specifically, the content ratio of the α-form PVDF-based resin and the content ratio of the β-form PVDF-based resin can be calculated, for example, as follows.

(1) A ¹⁹F-NMR spectrum is obtained from a porous layer containing a PVDF-based resin, under the following conditions.

### Measurement Conditions

Measurement device: AVANCE400 manufactured by Bruker Biospin

Measurement method: single-pulse method

Observed nucleus: ¹⁹F

Spectral bandwidth: 100 kHz

Pulse width: 3.0 s (90° pulse)

Pulse repetition time: 5.0 s

Reference material: C₆F₆ (external reference: −163.0 ppm)

Temperature: 22° C.

Sample rotation frequency: 25 kHz

(2) An integral value of a peak at around −78 ppm in the ¹⁹F-NMR spectrum obtained in (1) is calculated and is referred to as an amount α/2.
(3) As with the case of (2), an integral value of a peak at around −95 ppm in the ¹⁹F-NMR spectrum obtained in (1) is calculated and is referred to as an amount {(α/2)+β}.
(4) A content ratio (hereinafter, also referred to as “α ratio”) of the α-form PVDF-based resin with respect to 100 mol % of a total content of the α-form PVDF-based resin and a β-form PVDF-based resin is calculated, from the integral values obtained in (2) and (3), in accordance with the following Expression (1).

α ratio (mol %)=[(integral value at around −78 ppm)×2/{(integral value at around −95 ppm)+(integral value at around −78 ppm)}]×100 (1)

(5) A content ratio (hereinafter, also referred to as “β ratio”) of the β-form PVDF-based resin with respect to 100 mol % of the total content of the α-form PVDF-based resin and the β-form the PVDF-based resin is calculated, on the basis of the α ratio obtained in (4), in accordance with the following

Expression (2).

β ratio (mol %)=100 (mol %)−α ratio (mol %) (2)

(Method of Producing Porous Layer and Method of Nonaqueous Electrolyte Secondary Battery Laminated Separator)

A method of producing the porous layer in accordance with an embodiment of the present invention and a method of producing the nonaqueous electrolyte secondary battery laminated separator in accordance with an embodiment of the present invention are each not limited to any particular one, and any of various methods can be employed.

For example, the porous layer, containing the PVDF-based resin and optionally the filler, is formed, through one of processes (1) to (3) below, on the surface of the porous film serving as a base material. In the processes (2) and (3), the porous layer can be produced by drying a deposited porous layer for removal of a solvent. Note that, in the processes (1) to (3), in a case where a coating solution is used for production of the porous layer which contains the filler, the coating solution is preferably a coating solution in which the filler is dispersed and the PVDF-based resin is dissolved.

The coating solution used in the method of producing the porous layer in accordance with an embodiment of the present invention can be prepared normally by (i) dissolving, in the solvent, a resin to be contained in the porous layer and (ii) dispersing, in the solvent, the filler to be contained in the porous layer.

(1) A process of forming a porous layer by (i) coating a surface of a porous film with a coating solution containing a PVDF-based resin and optionally a filler, each of which is for forming the porous layer, and (ii) drying the coating solution so that a solvent (dispersion medium) contained in the coating solution is removed

(2) A process of depositing a porous layer by (i) coating a surface of a porous film with a coating solution, which is described in the process (1), and then (ii) immersing the porous film in a deposition solvent, which is a poor solvent for the PVDF-based resin.

(3) A process of depositing a porous layer by (i) coating a surface of a porous film with a coating solution, which is described in the process (1), and then (ii) acidifying the coating solution with use of a low-boiling-point organic acid.

Examples of the solvent (dispersion medium) contained in the coating solution include N-methylpyrrolidone, N,N-dimethylacetamide, N,N-dimethylformamide, acetone, and water.

The deposition solvent is preferably isopropyl alcohol or t-butyl alcohol, for example.

In the process (3), the low-boiling-point organic acid can be, for example, paratoluene sulfonic acid or acetic acid.

The coating solution can contain, as a component other than the above resin and fine particles, an additive(s) such as a disperser, a plasticizer, a surfactant, and/or a pH adjustor, as appropriate.

Note that the base material can be, other than the porous film, a film of another kind, a positive electrode plate, a negative electrode plate, or the like.

The coating solution can be applied to the base material by a conventionally known method. Specific examples of such a method include a gravure coater method, a dip coater method, a bar coater method, and a die coater method.

(Method of Controlling Crystal Forms of PVDF-Based Resin)

A crystal form of the PVDF-based resin contained in the porous layer in accordance with an embodiment of the present invention can be controlled by adjusting, in the above-described method, (i) drying conditions such as a drying temperature and an air velocity and an air direction during drying and/or (ii) a deposition temperature in a case where the porous layer containing the PVDF-based resin is deposited with use of the deposition solvent or the low-boiling-point organic acid.

In order to attain the PVDF-based resin arranged such that the content of the α-form PVDF-based resin is not less than 35.0 mol % with respect to 100 mol % of the total content of the α-form PVDF-based resin and the β-form PVDF-based resin in the PVDF-based resin, the drying conditions and the deposition temperature can be changed as appropriate in accordance with the method of producing the porous layer, the solvent (dispersion medium) as used, types of the deposition solvent and the low-boiling-point organic acid, and the like.

In a case where the coating solution is simply dried as in the process (1), the drying conditions can be changed as appropriate in accordance with, for example, the solvent contained in the coating solution, a concentration of the PVDF-based resin contained in the coating solution, an amount of the filler contained in the coating solution (if contained), and/or an amount of the coating solution with which the surface of the porous film is coated. In a case where the porous layer is formed through the process (1), it is preferable that the drying temperature be 30° C. to 100° C., that a direction of hot air for drying be perpendicular to the porous film or an electrode sheet which is coated with the coating solution, and that a velocity of the hot air be 0.1 m/s to 40 m/s. Specifically, in a case where the coating solution to be applied contains (i) N-methyl-2-pyrrolidone as the solvent for dissolving the PVDF-based resin, (ii) 1.0% by mass of the PVDF-based resin, and (iii) 9.0% by mass of alumina as an inorganic filler, the drying conditions are preferably adjusted so that the drying temperature is 40° C. to 100° C., that the direction of the hot air for drying is perpendicular to the porous film or the electrode sheet which is coated with the coating solution, and that the velocity of the hot air is 0.4 m/s to 40 m/s.

In a case where the porous layer is formed through the process (2), it is preferable that the deposition temperature be −25° C. to 60° C. and that the drying temperature be 20° C. to 100° C. Specifically, in a case where the porous layer is formed through the process (2) with use of (i) N-methylpyrrolidone as the solvent for dissolving the PVDF-based resin and (ii) isopropyl alcohol as the deposition solvent, it is preferable that the deposition temperature be −10° C. to 40° C. and that the drying temperature be 30° C. to 80° C.

(Another Porous Layer)

The nonaqueous electrolyte secondary battery in accordance with an embodiment of the present invention can include another porous layer in addition to (i) the porous film and (ii) the porous layer containing the PVDF-based resin. The another porous layer need only be provided between the nonaqueous electrolyte secondary battery separator and at least one of the positive electrode plate and the negative electrode plate. The porous layer and the another porous layer may be provided in any order with respect to the nonaqueous electrolyte secondary battery separator. In a preferable configuration, the porous film, the another porous layer, and the porous layer containing the PVDF-based resin are disposed in this order. In other words, the another porous layer is provided between the porous film and the porous layer containing the PVDF-based resin. In another preferable configuration, the another porous layer and the porous layer containing the PVDF-based resin are provided in this order on both surfaces of the porous film.

The another porous layer in accordance with an embodiment of the present invention can contain, for example, any of polyolefins; (meth)acrylate-based resins; fluorine-containing resins (excluding polyvinylidene fluoride-based resins); polyamide-based resins; polyimide-based resins; polyester-based resins; rubbers; resins each having a melting point or a glass transition temperature of not lower than 180° C.; water-soluble polymers; polycarbonate, polyacetal, and polyether ether ketone.

Among the above resins, polyolefins, (meth)acrylate-based resins, polyamide-based resins, polyester-based resins and water-soluble polymers are preferable.

Preferable examples of the polyolefins include polyethylene, polypropylene, polybutene, and an ethylene-propylene copolymer.

Examples of the fluorine-containing resins include polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Preferable examples of the fluorine-containing resins include fluorine-containing rubber having a glass transition temperature of not higher than 23° C.

Preferable examples of the polyamide-based resins include aramid resins such as aromatic polyamides and wholly aromatic polyamides.

Specific examples of the aramid resins include poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, and a metaphenylene terephthalamide/2,6-dichloroparaphenylene terephthalamide copolymer. Among those aramid resins, poly(paraphenylene terephthalamide) is more preferable.

The polyester-based resins are preferably aromatic polyesters, such as polyarylates, and liquid crystal polyesters.

Examples of the rubbers include a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate.

Examples of the resins each having a melting point or a glass transition temperature of not lower than 180° C. include polyphenylene ether, polysulfone, polyether sulfone, polyphenylene sulfide, polyetherimide, polyamide imide, and polyether amide.

Examples of the water-soluble polymers include polyvinyl alcohol, polyethylene glycol, cellulose ether, sodium alginate, polyacrylic acid, polyacrylamide, and polymethacrylic acid.

Note that, as a resin used for the another porous layer, it is possible to use only one kind of resin or two or more kinds of resins in combination.

The other characteristics (e.g., thickness) of the another porous layer are similar to those described in the section (Porous layer) above, except that the porous layer contains the PVDF-based resin.

<Positive Electrode Plate>

The positive electrode plate included in the nonaqueous electrolyte secondary battery in accordance with an embodiment of the present invention is not limited to any particular one, provided that the number of bends of the positive electrode plate falls within a specific range, which number of bends is measured in a folding endurance test as described later. For example, as the positive electrode active material layer, a sheet-shaped positive electrode plate is used which includes (i) a positive electrode mix containing a positive electrode active material, an electrically conductive agent, and a binding agent and (ii) a positive electrode current collector supporting the positive electrode mix thereon. Note that the positive electrode plate can be arranged such that the positive electrode current collector supports the positive electrode mix on one surface or each of both surfaces of the positive electrode current collector.

The positive electrode active material is, for example, a material capable of being doped with and dedoped of lithium ions. Such a material is preferably a transition metal oxide. Specific examples of the transition metal oxide include a lithium complex oxide containing at least one transition metal such as V, Mn, Fe, Co, or Ni.

Examples of the electrically conductive agent include carbonaceous materials such as natural graphite, artificial graphite, cokes, carbon black, pyrolytic carbons, carbon fiber, and a fired product of an organic polymer compound. It is possible to use only one kind of electrically conductive agent or two or more kinds of electrically conductive agents in combination.

Examples of the binding agent include: thermoplastic resins such as polyvinylidene fluoride, a copolymer of vinylidene fluoride, polytetrafluoroethylene, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-hexafluoropropylene copolymer, a vinylidene fluoride-hexafluoropropylene-tetrafluoroethylene copolymer, a thermoplastic polyimide, polyethylene, and polypropylene; an acrylic resin; and styrene-butadiene rubber. Note that the binding agent functions also as a thickener.

Examples of the positive electrode current collector include electric conductors such as Al, Ni, and stainless steel. Among these electric conductors, Al is more preferable because Al is easily processed into a thin film and is inexpensive.

<Negative Electrode Plate>

The negative electrode plate included in the nonaqueous electrolyte secondary battery in accordance with an embodiment of the present invention is not limited to any particular one, provided that the number of bends of the negative electrode plate falls within a specific range, which number of bends is measured in a folding endurance test as described later. For example, as the negative electrode active material layer, a sheet-shaped negative electrode plate is used which includes (i) a negative electrode mix containing a negative electrode active material and (ii) a negative electrode current collector supporting the negative electrode mix thereon. The sheet-shaped negative electrode plate preferably contains an electrically conductive agent as described above and a binding agent as described above. Note that the negative electrode plate can be arranged such that the negative electrode current collector supports the negative electrode mix on one surface or each of both surfaces of the negative electrode current collector.

Examples of the negative electrode active material include (i) a material capable of being doped with and dedoped of lithium ions, (ii) lithium metal, and (iii) lithium alloy. Examples of such a material include carbonaceous materials. Examples of the carbonaceous materials include natural graphite, artificial graphite, cokes, carbon black, and pyrolytic carbons. The electrically conductive agent can be any of the above-described electrically conductive agents which can be contained in the positive electrode active material layer. Meanwhile, the binding agent can be any of the above-described binding agents which can be contained in the positive electrode active material layer.

Examples of the negative electrode current collector include Cu, Ni, and stainless steel. In particular, Cu is more preferable because Cu is not easily alloyed with lithium in a lithium-ion secondary battery and is easily processed into a thin film.

<Number of Bends>

In a case where the positive electrode plate and the negative electrode plate in accordance with an embodiment of the present invention are each subjected to the folding endurance test in conformity with an MIT tester method, which is specified in JIS P 8115 (1994), so as to measure (i) how many times the positive electrode plate is bent before peeling of the positive electrode active material layer occurs (herein, also referred to as “number of bends before peeling”) and (ii) how many times the negative electrode plate is bent before peeling of the negative electrode active material layer occurs (herein, referred to as “number of bends before peeling”), the number of bends of the positive electrode plate and the number of bends of the negative electrode plate fall within respective specific ranges. The folding endurance test is carried out at a load of 1 N and a bending angle of 45°. According to a nonaqueous electrolyte secondary battery, an active material may expand or shrink during a process of charge-discharge cycles. As the number of bends before peeling of an electrode active material layer, which number of bends is measured in the above-described folding endurance test, becomes larger, it becomes easier for an entire electrode to isotropically follow expansion and shrinkage of the active material. Therefore, as the number of bends becomes larger, it becomes easier to keep adhesion between components (an active material, an electrically conductive agent, and a binding agent) contained inside the electrode active material layer, and it becomes also easier to keep adhesion between the electrode active material layer and a current collector. This makes it possible to prevent a degradation of the nonaqueous electrolyte secondary battery during the process of charge-discharge cycles.

In the folding endurance test, the number of bends of the positive electrode plate before peeling of the positive electrode active material layer is preferably not less than 130, and more preferably not less than 150. Meanwhile, in the folding endurance test, the number of bends of the negative electrode plate before peeling of the negative electrode active material layer is preferably not less than 1650, more preferably not less than 1800, and still more preferably not less than 2000.

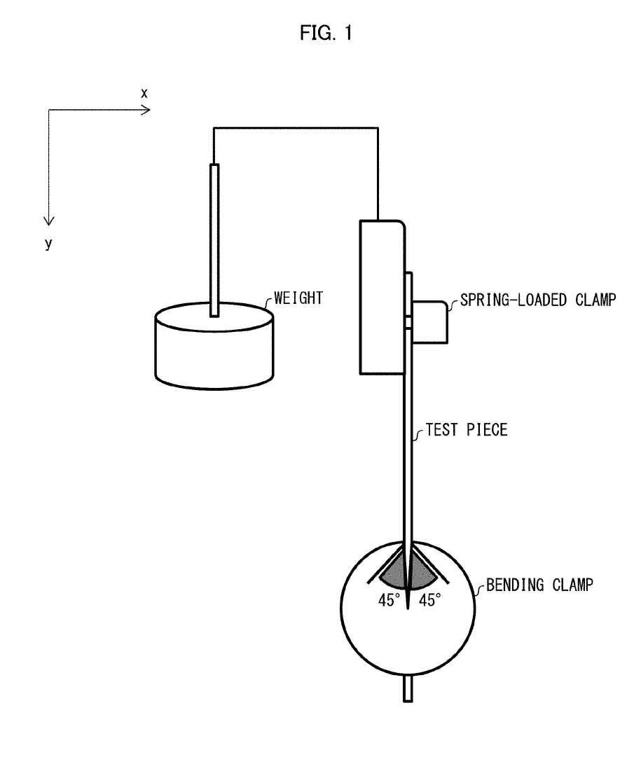

FIG. 1 is a diagram schematically illustrating an MIT tester which is used for the MIT tester method. In FIG. 1, an x axis represents a horizontal direction and a y axis represents a vertical direction. An outline of the MIT tester method will be described below. The MIT tester includes a spring-loaded clamp and a bending clamp. One longitudinal end of a test piece is clamped by the spring-loaded clamp, while the other longitudinal end of the test piece is clamped by the bending clamp. The test piece is thereby fixed. The spring-loaded clamp is connected with a weight. In the above folding endurance test, a load of 1 N is applied by the weight. The test piece is thus tensioned in a longitudinal direction of the test piece. In this state, the longitudinal direction of the test piece is parallel to the vertical direction. The bending clamp is then rotated so that the test piece is bent. In the folding endurance test, a bending angle in this bending is 45°. In other words, the test piece is bent to right by 45° and left by 45° with respect to the vertical direction. A speed at which the test piece is bent to right and left (bending speed) is 175 reciprocations/min.

<Method of Producing Positive Electrode Plate and Method of Producing Negative Electrode Plate>

Examples of a method of producing the sheet-shaped positive electrode plate include: a method in which a positive electrode active material, an electrically conductive agent, and a binding agent are pressure-molded on a positive electrode current collector; and a method in which (i) a positive electrode active material, an electrically conductive agent, and a binding agent are formed into a paste with use of a suitable organic solvent, (ii) a positive electrode current collector is coated with the paste, and then (iii) the paste in a wet state or after being dried is pressured so that the paste is firmly fixed to the positive electrode current collector.

Similarly, examples of a method of producing the sheet-shaped negative electrode plate include: a method in which a negative electrode active material is pressure-molded on a negative electrode current collector; and a method in which (i) a negative electrode active material is formed into a paste with use of a suitable organic solvent, (ii) a negative electrode current collector is coated with the paste, and then (iii) the paste in a wet state or after being dried is pressured so that the paste is firmly fixed to the negative electrode current collector. The paste preferably contains an electrically conductive agent as described above and a binding agent as described above.

Note, here, that the above-described number of bends can be controlled by further applying pressure to the positive electrode plate or the negative electrode plate which has been obtained as above. Specifically, it is possible to control the above-described number of bends by adjusting a time length for applying pressure, the pressure, a method of applying the pressure, and/or the like. The time length for applying the pressure is preferably 1 second to 3,600 seconds, and more preferably 1 second to 300 seconds. The pressure can be applied by confining the positive electrode plate or the negative electrode plate. The pressure applied by such confining is herein also referred to as “confining pressure”. The confining pressure is preferably 0.01 MPa to 10 MPa, and more preferably 0.01 MPa to 5 MPa. Further, the pressure can be applied while the positive electrode plate or the negative electrode plate is wet with an organic solvent. This can increase adhesion between components contained inside the electrode active material layer and adhesion between the electrode active material layer and the current collector. Examples of the organic solvent include carbonates, ethers, esters, nitriles, amides, carbamates, sulfur-containing compounds, and fluorine-containing organic solvents each obtained by introducing a fluorine group into any of these organic solvents.

<Nonaqueous Electrolyte>

A nonaqueous electrolyte, which can be contained in the nonaqueous electrolyte secondary battery in accordance with an embodiment of the present invention, is not limited to any particular one, provided that the nonaqueous electrolyte is one that is generally used for a nonaqueous electrolyte secondary battery. The nonaqueous electrolyte can be, for example, a nonaqueous electrolyte obtained by dissolving a lithium salt in an organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is possible to use only one kind of lithium salt or two or more kinds of lithium salts in combination.

Examples of the organic solvent contained in the nonaqueous electrolyte include carbonates, ethers, esters, nitriles, amides, carbamates, sulfur-containing compounds, and fluorine-containing organic solvents each obtained by introducing a fluorine group into any of these organic solvents. It is possible to use only one kind of organic solvent or two or more kinds of organic solvents in combination.

<Method of Producing Nonaqueous Electrolyte Secondary Battery>

The nonaqueous electrolyte secondary battery in accordance with an embodiment of the present invention can be produced by, for example, (i) forming a member for a nonaqueous electrolyte secondary battery (hereinafter referred to as a “nonaqueous electrolyte secondary battery member”) by disposing the positive electrode plate, the porous layer, the nonaqueous electrolyte secondary battery separator, and the negative electrode plate in this order, (ii) placing the nonaqueous electrolyte secondary battery member in a container which is to serve as a housing of the nonaqueous electrolyte secondary battery, (iii) filling the container with the nonaqueous electrolyte, and then (iv) hermetically sealing the container while reducing pressure inside the container.

The nonaqueous electrolyte secondary battery in accordance with an embodiment of the present invention includes the nonaqueous electrolyte secondary battery separator including the polyolefin porous film, the porous layer, the positive electrode plate, and the negative electrode plate, as described above. The nonaqueous electrolyte secondary battery in accordance with an embodiment of the present invention satisfies, in particular, the following requirements (i) to (iv).

(i) The polyvinylidene fluoride-based resin contained in the porous layer is arranged such that the content of the α-form polyvinylidene fluoride-based resin is not less than 35.0 mol % with respect to 100 mol % of the total content of the α-form polyvinylidene fluoride-based resin and the β-form polyvinylidene fluoride-based resin in the polyvinylidene fluoride-based resin.
(ii) The positive electrode plate is arranged such that the number of bends of the positive electrode plate is not less than 130, the number of bends indicating how many times the positive electrode plate is bent before peeling of the positive electrode active material layer occurs in the folding endurance test according to the MIT tester method specified in JIS P 8115 (1994), the folding endurance test being carried out under conditions of a load of 1 N and a bending angle of 45°.
(iii) The negative electrode plate is arranged such that the number of bends of the negative electrode plate is not less than 1650, the number of bends indicating how many times the negative electrode plate is bent before peeling of the negative electrode active material layer occurs in the folding endurance test according to the MIT tester method specified in JIS P 8115 (1994), the folding endurance test being carried out under conditions of a load of 1 N and a bending angle of 45°.
(iv) The porous film is arranged such that the porous film has a temperature rise ending time of 2.9 seconds·m²/g to 5.7 seconds·m²/g with respect to the resin content per unit area, in a case where the porous film is impregnated with N-methylpyrrolidone containing 3% by weight of water and is irradiated with a microwave having a frequency of 2455 MHz and an output of 1800 W.

By satisfying the requirement (iv), it is possible to, in the nonaqueous electrolyte secondary battery in accordance with an embodiment of the present invention, control (a) the capability to supply the electrolyte from the polyolefin porous film to the electrodes, (b) the capillary force in the pores, and (c) the area of the walls of the pores to fall with respective specific ranges. This ultimately makes it possible to prevent the electrolyte from being depleted and prevent the pores from being blocked. Furthermore, by satisfying the requirement (i), it is possible to, in the nonaqueous electrolyte secondary battery in accordance with an embodiment of the present invention, prevent plastic deformation of the polyvinylidene fluoride-based resin at high temperatures. This ultimately makes it possible to prevent structural deformation of the porous layer and prevent blockage of the pores in the porous layer. Moreover, by satisfying the requirements (ii) and (iii), it is possible to easily keep adhesion between the components contained inside the electrode active material layer and adhesion between the electrode active material layer and the current collector.

Therefore, according to the nonaqueous electrolyte secondary battery which satisfies the requirements (i) to (iv), it is possible to (a) cause movement of the electrolyte to be less prevented by blockage of the pores in the polyolefin porous film and in the porous layer which blockage is caused by deformation of the structure of the pores which deformation is caused by charge-discharge cycles and (b) control adhesion of an electrode plate during the charge-discharge cycles. As result, it is considered that the nonaqueous electrolyte secondary battery which satisfies the requirements (i) to (iv) has an improved capacity maintenance rate in the 100th charge-discharge cycle.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss embodiments of the present invention in more detail with reference to Examples and Comparative Examples. Note, however, that the present invention is not limited to such Examples and Comparative Examples.

[Measurement Methods]

In Examples and Comparative Examples, measurements were carried out by the following methods.

(1) Folding Endurance Test

A test piece having a size of length 105 mm×width 15 mm was cut out from a positive electrode plate or a negative electrode plate obtained in each of Examples and Comparative Examples below. The test piece was subjected to a folding endurance test according to the MIT tester method.

The folding endurance test was carried out, with use of an MIT type folding endurance tester (manufactured by YASUDA SEIKI SEISAKUSHO, LTD.), in conformity with the MIT tester method specified in JIS P 8115 (1994). In the folding endurance test, one end of the test piece was fixed, and the test piece was bent to right and left each at a bending angle of 45° under the conditions of a load of 1 N, a bending portion radius R of 0.38 mm, and a bending speed of 175 reciprocations/min.

The number of bends was counted until an electrode active material layer peeled from the positive electrode plate or negative electrode plate. The number of bends here is the number of reciprocating bend motions which number is displayed on a counter of the MIT type folding endurance tester.

(2) Film Thickness (Unit: μm)

A thickness of a porous film was measured with use of a high-precision digital measuring device (VL-50) manufactured by Mitutoyo Corporation.

(3) Method of Calculating a Ratio

A test piece having a size of approximately 2 cm×5 cm was cut out from a laminated separator obtained in each of Examples and Comparative Examples below. A content ratio (α ratio) of an α-form PVDF-based resin in a PVDF-based resin contained in the test piece thus cut out from the laminated separator was measured according to steps (1) to (4) of the above-described (Method of calculating content ratios of α-form PVDF-based resin and β-form PVDF-based resin in PVDF-based resin).

(4) Temperature Rise Ending Time at Irradiation with Microwave

A test piece having a size of 8 mm×8 mm was cut out from a porous film obtained in each of Examples and Comparative Examples below, and a weight W (g) of the test piece was measured. A weight per unit area of the test piece was calculated in accordance with the following expression: weight per unit area (g/m²)=W/(0.08×0.08).

Next, the test piece was impregnated with N-methylpyrrolidone (NMP) containing 3% by weight of water. Then, the test piece was placed on a Teflon (registered trademark) sheet (size: 12 cm×10 cm). The test piece was folded in half in such a manner as to sandwich an optical fiber thermometer (manufactured by ASTEC Co., Ltd., Neoptix Reflex thermometer) coated with polytetrafluoroethylene (PTFE).

Next, the test piece, which had been impregnated with water-containing NMP and had been so folded as to sandwich the thermometer, was fixed in a microwave irradiation device (manufactured by Micro Denshi Co., Ltd., 9-kW microwave oven; frequency: 2455 MHz) equipped with a turntable. The test piece was then irradiated with a microwave at 1800 W for 2 minutes. Note that a temperature of a surface of the test piece immediately before irradiation with the microwave was adjusted to 29±1° C.

A temperature of an atmosphere in the device at the irradiation with the microwave was 27° C. to 30° C.

Subsequently, the optical fiber thermometer was used to measure, every 0.2 seconds, changes in temperature of the test piece after the start of the irradiation with the microwave. In such temperature measurements, the temperature at which no temperature rise was measured for not less than 1 second was used as a temperature rise ending temperature, and a time period which elapsed before the temperature rise ending temperature was reached after the start of the irradiation with the microwave was used as a temperature rise ending time. The temperature rise ending time thus obtained was divided by the above weight per unit area for calculation of a temperature rise ending time with respect to a resin content per unit area.

(5) Capacity Maintenance Rate in the 100th Charge-Discharge Cycle

A capacity maintenance rate in the 100th charge-discharge cycle of a nonaqueous electrolyte secondary battery produced in each of Examples and Comparative Examples below was measured by a method including the following steps (A) and (B).

(A) Initial Charge-Discharge Test

A new nonaqueous electrolyte secondary battery, which had been produced in each of Examples and Comparative

Examples and which had not been subjected to any charge-discharge cycle, was subjected to 4 initial charge-discharge cycles. Each of the 4 initial charge-discharge cycles was carried out under the following conditions: (i) a temperature was set to 25° C.; (ii) a voltage was set to a range of 2.7 V to 4.1 V; (iii) CC-CV charge was carried out at a rate of 0.2 C (final rate: 0.02 C); and (iv) CC discharge was carried out at a rate of 0.2 C. Note that 1 C indicates a rate at which a rated capacity derived from a 1-hour rate discharge capacity is discharged in 1 hour. The same applies to the following description. Note, here, that the “CC-CV charge” is a charging method in which (i) a battery is charged with a set constant electric current and (ii) after a certain voltage is reached, the certain voltage is maintained while the electric current is reduced. Note also that the “CC discharge” is a discharging method in which a battery is discharged with a set constant electric current until a certain voltage is reached. The same applies to the following description.

(B) Charge-Discharge Cycle Test

The nonaqueous electrolyte secondary battery, which had been subjected to the above initial charge-discharge test, was subjected to 100 charge-discharge cycles. Each of the 100 charge-discharge cycles was carried out under the following conditions: (i) a temperature was set to 55° C.; (ii) a voltage was set to a range of 2.7 V to 4.2 V; (iii) CC-CV charge was carried out at a rate of 1 C (final rate: 0.02 C); and (iv) CC discharge was carried out at a rate of 10 C.

A discharge capacity in the 100th charge-discharge cycle was divided by the discharge capacity in the 1st charge-discharge cycle, and a quotient was used as the capacity maintenance rate in the 100th charge-discharge cycle. Table 1 shows the capacity maintenance rate in the 100th charge-discharge cycle.

### Example 1

[Production of Nonaqueous Electrolyte Secondary Battery Laminated Separator]

Ultra-high molecular weight polyethylene powder (GUR4032, manufactured by Ticona Corporation) having a weight-average molecular weight of 4,970,000 and polyethylene wax (FNP-0115, manufactured by Nippon Seiro Co., Ltd.) having a weight-average molecular weight of 1,000 were mixed together for preparation of a mixture containing the ultra-high molecular weight polyethylene powder in a proportion of 70% by weight and the polyethylene wax in a proportion of 30% by weight. Then, 0.4 parts by weight of an antioxidant (Irg1010, manufactured by Ciba Specialty Chemicals Corporation), 0.1 parts by weight of an antioxidant (P168, manufactured by Ciba Specialty Chemicals Corporation), and 1.3 parts by weight of sodium stearate were added to 100 parts by weight of the mixture of the ultra-high molecular weight polyethylene powder and the polyethylene wax. Note, here, the total amount of the ultra-high molecular weight polyethylene powder and the polyethylene wax in the mixture was assumed to be 100 parts by weight. Furthermore, calcium carbonate having an average particle diameter of 0.1 μm (manufactured by Maruo Calcium Co., Ltd.) was added to a resultant mixture so that a volume of the calcium carbonate was 36% by volume with respect to an entire volume of the mixture. A resultant mixture was mixed as it was, that is, in the form of powder, in a Henschel mixer, and then the mixture was melt-kneaded with use of a twin screw kneading extruder. This produced a polyolefin resin composition.

Next, the polyolefin resin composition was rolled with use of a pair of rollers each having a surface temperature of 150° C. This produced a sheet of the polyolefin resin composition. The sheet was immersed in an aqueous hydrochloric acid solution (which contained 4 mol/L of hydrochloric acid and 0.5% by weight of a nonionic surfactant) so that the calcium carbonate was removed. Subsequently, the sheet was stretched at 100° C. to 105° C. and at a strain rate of 750% per minute so that the sheet was 6.2 times larger. This produced a film having a film thickness of 16.3 μm. The film was then subjected to heat fixation treatment at 115° C., so that a porous film 1 was obtained.

An N-methyl-2-pyrrolidone (hereinafter also referred to as “NMP”) solution (manufactured by Kureha Corporation; product name: L#9305, weight-average molecular weight: 1,000,000) containing a PVDF-based resin (polyvinylidene fluoride-hexafluoropropylene copolymer) was prepared as a coating solution 1. The coating solution 1 was applied to the porous film 1 by a doctor blade method so that the PVDF-based resin in the coating solution 1 thus applied to the porous film 1 weighed 6.0 g per square meter of the porous film 1.

The porous film 1, to which the coating solution 1 had been applied, was immersed into 2-propanol in a state where a coating film was wet with a solvent, and was then left to stand still at 25° C. for 5 minutes. This produced a laminated porous film 1. The laminated porous film 1 thus obtained was further immersed into the other 2-propanol in a state where the laminated porous film 1 was wet with the above immersion solvent, and was then left to stand still at 25° C. for 5 minutes. This produced a laminated porous film 1a. The laminated porous film 1a thus produced was dried at 65° C. for 5 minutes, so that a laminated separator 1 including the porous film 1 and a porous layer disposed on the porous film 1 was obtained. Table 1 shows results of evaluation of the laminated separator 1.

[Preparation of Nonaqueous Electrolyte Secondary Battery]

(Positive Electrode Plate)

A positive electrode plate was obtained which was arranged such that a positive electrode mix (a mixture of LiNi_{0.5}Mn_{0.3}Co_{0.2}O₂, an electrically conductive agent, and PVDF (at a weight ratio of 92:5:3)) was disposed on one surface of a positive electrode current collector (aluminum foil). Confining pressure (0.7 MPa) was applied to the positive electrode plate at a room temperature for 30 seconds.

The positive electrode plate was cut so that (i) a first portion of a resultant positive electrode plate, on which first portion a positive electrode active material layer was disposed, had a size of 45 mm×30 mm and (ii) a second portion of the resultant positive electrode plate, on which second portion no positive electrode active material layer was disposed and which second portion had a width of 13 mm, was present around the first portion. The resultant positive electrode plate was used as a positive electrode plate 1.

(Negative Electrode Plate)

A negative electrode plate was obtained which was arranged such that a negative electrode mix (a mixture of natural graphite, a styrene-1,3-butadiene copolymer, and sodium carboxymethyl cellulose (at a weight ratio of 98:1:1)) was disposed on one surface of a negative electrode current collector (copper foil). Confining pressure (0.7 MPa) was applied to the negative electrode plate at a room temperature for 30 seconds.

The negative electrode plate was cut so that (i) a first portion of a resultant negative electrode plate, on which first portion a negative electrode active material layer was disposed, had a size of 50 mm×35 mm and (ii) a second portion of the resultant negative electrode plate, on which second portion no negative electrode active material layer was disposed and which second portion had a width of 13 mm, was present around the first portion. The resultant negative electrode plate was used as a negative electrode plate 1.

(Assembly of Nonaqueous Electrolyte Secondary Battery)

A nonaqueous electrolyte secondary battery was produced by the following method with use of the positive electrode plate 1, the negative electrode plate 1, and the laminated separator 1.

The positive electrode plate 1, the laminated separator 1, and the negative electrode plate 1 were disposed (arranged) in this order in a laminate pouch so that the porous layer included in the laminated separator 1 faced the positive electrode plate 1. This produced a nonaqueous electrolyte secondary battery member 1. In so doing, the positive electrode plate 1 and the negative electrode plate 1 were arranged such that a main surface of the positive electrode active material layer of the positive electrode plate 1 was entirely included in a range of a main surface of the negative electrode active material layer of the negative electrode plate 1 (i.e., entirely covered by the main surface of the negative electrode active material layer of the negative electrode plate 1).

Subsequently, the nonaqueous electrolyte secondary battery member 1 was put into a bag which had been formed by disposing an aluminum layer on a heat seal layer. Further, 0.23 mL of a nonaqueous electrolyte was put into the bag. The nonaqueous electrolyte was a nonaqueous electrolyte prepared by dissolving LiPF₆ in a mixed solvent of ethylene carbonate, ethyl methyl carbonate, and diethyl carbonate (at a volume ratio of 3:5:2) so that a concentration of the LiPF₆ became 1 mol/L. The bag was then heat-sealed while the pressure inside the bag was reduced. This produced a nonaqueous electrolyte secondary battery 1.

Thereafter, a capacity maintenance rate in the 100th charge-discharge cycle of the nonaqueous electrolyte secondary battery 1 obtained by the above method was measured. Table 1 shows results of measurement.

### Example 2

[Production of Nonaqueous Electrolyte Secondary Battery Laminated Separator]

Ultra-high molecular weight polyethylene powder (GUR4032, manufactured by Ticona Corporation) having a weight-average molecular weight of 4,970,000 and polyethylene wax (FNP-0115, manufactured by Nippon Seiro Co., Ltd.) having a weight-average molecular weight of 1,000 were mixed together for preparation of a mixture containing the ultra-high molecular weight polyethylene powder in a proportion of 70% by weight and the polyethylene wax in a proportion of 30% by weight. Then, 0.4 parts by weight of an antioxidant (Irg1010, manufactured by Ciba Specialty Chemicals Corporation), 0.1 parts by weight of an antioxidant (P168, manufactured by Ciba Specialty Chemicals Corporation), and 1.3 parts by weight of sodium stearate were added to 100 parts by weight of the mixture of the ultra-high molecular weight polyethylene powder and the polyethylene wax. Note, here, the total amount of the ultra-high molecular weight polyethylene powder and the polyethylene wax in the mixture was assumed to be 100 parts by weight. Furthermore, calcium carbonate having an average particle diameter of 0.1 μm (manufactured by Maruo Calcium Co., Ltd.) was added to a resultant mixture so that a volume of the calcium carbonate was 36% by volume with respect to an entire volume of the mixture. A resultant mixture was mixed as it was, that is, in the form of powder, in a Henschel mixer, and then the mixture was melt-kneaded with use of a twin screw kneading extruder. This produced a polyolefin resin composition.

Next, the polyolefin resin composition was rolled with use of a pair of rollers each having a surface temperature of 150° C. This produced a sheet of the polyolefin resin composition. The sheet was immersed in an aqueous hydrochloric acid solution (which contained 4 mol/L of hydrochloric acid and 0.5% by weight of a nonionic surfactant) so that the calcium carbonate was removed. Subsequently, the sheet was stretched at 100° C. to 105° C. and at a strain rate of 1250% per minute so that the sheet was 6.2 times larger. This produced a film having a film thickness of 15.5 μm. The film was then subjected to heat fixation treatment at 120° C., so that a porous film 2 was obtained.

Then, a coating solution 1 was applied to the porous film 2 as in Example 1. The porous film 2, to which the coating solution 1 had been applied, was immersed into 2-propanol in a state where a coating film was wet with a solvent, and was then left to stand still at −10° C. for 5 minutes. This produced a laminated porous film 2. The laminated porous film 2 thus obtained was further immersed into the other 2-propanol in a state where the laminated porous film 2 was wet with the above immersion solvent, and was then left to stand still at 25° C. for 5 minutes. This produced a laminated porous film 2a. The laminated porous film 2a thus produced was dried at 30° C. for 5 minutes, so that a laminated separator 2 including the porous film 2 and a porous layer disposed on the porous film 2 was obtained. Table 1 shows results of evaluation of the laminated separator 2.

[Preparation of Nonaqueous Electrolyte Secondary Battery]

A nonaqueous electrolyte secondary battery was prepared as in Example 1, except that the laminated separator 2 was used in place of the laminated separator 1. The nonaqueous electrolyte secondary battery thus prepared was referred to as a nonaqueous electrolyte secondary battery 2.

Thereafter, a capacity maintenance rate in the 100th charge-discharge cycle of the nonaqueous electrolyte secondary battery 2 obtained by the above method was measured. Table 1 shows results of measurement.

### Example 3

[Production of Nonaqueous Electrolyte Secondary Battery Laminated Separator]

Ultra-high molecular weight polyethylene powder (GUR4032, manufactured by Ticona Corporation) having a weight-average molecular weight of 4,970,000 and polyethylene wax (FNP-0115, manufactured by Nippon Seiro Co., Ltd.) having a weight-average molecular weight of 1,000 were mixed together for preparation of a mixture containing the ultra-high molecular weight polyethylene powder in a proportion of 71% by weight and the polyethylene wax in a proportion of 29% by weight. Then, 0.4 parts by weight of an antioxidant (Irg1010, manufactured by Ciba Specialty Chemicals Corporation), 0.1 parts by weight of an antioxidant (P168, manufactured by Ciba Specialty Chemicals Corporation), and 1.3 parts by weight of sodium stearate were added to 100 parts by weight of the mixture of the ultra-high molecular weight polyethylene powder and the polyethylene wax. Note, here, the total amount of the ultra-high molecular weight polyethylene powder and the polyethylene wax in the mixture was assumed to be 100 parts by weight. Furthermore, calcium carbonate having an average particle diameter of 0.1 μm (manufactured by Maruo Calcium Co., Ltd.) was added to a resultant mixture so that a volume of the calcium carbonate was 37% by volume with respect to an entire volume of the mixture. A resultant mixture was mixed as it was, that is, in the form of powder, in a Henschel mixer, and then the mixture was melt-kneaded with use of a twin screw kneading extruder. This produced a polyolefin resin composition.

Next, the polyolefin resin composition was rolled with use of a pair of rollers each having a surface temperature of 150° C. This produced a sheet of the polyolefin resin composition. The sheet was immersed in an aqueous hydrochloric acid solution (which contained 4 mol/L of hydrochloric acid and 0.5% by weight of a nonionic surfactant) so that the calcium carbonate was removed. Subsequently, the sheet was stretched at 100° C. to 105° C. and at a strain rate of 2100% per minute so that the sheet was 7.0 times larger. This produced a film having a film thickness of 11.7 μm. The film was then subjected to heat fixation treatment at 123° C., so that a porous film 3 was obtained.

Then, a coating solution 1 was applied to the porous film 3 as in Example 1. The porous film 3, to which the coating solution 1 had been applied, was immersed into 2-propanol in a state where a coating film was wet with a solvent, and was then left to stand still at −5° C. for 5 minutes. This produced a laminated porous film 3. The laminated porous film 3 thus obtained was further immersed into the other 2-propanol in a state where the laminated porous film 3 was wet with the above immersion solvent, and was then left to stand still at 25° C. for 5 minutes. This produced a laminated porous film 3a. The laminated porous film 3a thus produced was dried at 30° C. for 5 minutes, so that a laminated separator 3 including the porous film 3 and a porous layer disposed on the porous film 3 was obtained. Table 1 shows results of evaluation of the laminated separator 3.

[Preparation of Nonaqueous Electrolyte Secondary Battery]

A nonaqueous electrolyte secondary battery was prepared as in Example 1, except that the laminated separator 3 was used in place of the laminated separator 1. The nonaqueous electrolyte secondary battery thus prepared was referred to as a nonaqueous electrolyte secondary battery 3.

Thereafter, a capacity maintenance rate in the 100th charge-discharge cycle of the nonaqueous electrolyte secondary battery 3 obtained by the above method was measured. Table 1 shows results of measurement.

### Example 4

(Positive Electrode Plate)

A positive electrode plate was obtained which was arranged such that a positive electrode mix (a mixture of LiCoO₂, an electrically conductive agent, and PVDF (at a weight ratio of 100:5:3)) was disposed on one surface of a positive electrode current collector (aluminum foil). Confining pressure (0.7 MPa) was applied to the positive electrode plate at a room temperature for 30 seconds in a state where the positive electrode plate was wet with diethyl carbonate.

The positive electrode plate was cut so that (i) a first portion of a resultant positive electrode plate, on which first portion a positive electrode active material layer was disposed, had a size of 45 mm×30 mm and (ii) a second portion of the resultant positive electrode plate, on which second portion no positive electrode active material layer was disposed and which second portion had a width of 13 mm, was present around the first portion. The resultant positive electrode plate was used as a positive electrode plate 2.

[Preparation of Nonaqueous Electrolyte Secondary Battery]

A negative electrode plate 1 was used as a negative electrode plate. A nonaqueous electrolyte secondary battery was prepared as in Example 1, except that a laminated separator 3 was used in place of the laminated separator 1 and that the positive electrode plate 2 was used as a positive electrode plate. The nonaqueous electrolyte secondary battery thus prepared was referred to as a nonaqueous electrolyte secondary battery 4.

Thereafter, a capacity maintenance rate in the 100th charge-discharge cycle of the nonaqueous electrolyte secondary battery 4 obtained by the above method was measured. Table 1 shows results of measurement.

### Example 5

(Negative Electrode Plate)

A negative electrode plate was obtained which was arranged such that a negative electrode mix (a mixture of natural graphite, a styrene-1,3-butadiene copolymer, and sodium carboxymethyl cellulose (at a weight ratio of 98:1:1)) was disposed on one surface of a negative electrode current collector (copper foil). Confining pressure (0.7 MPa) was applied to the negative electrode plate at a room temperature for 30 seconds in a state where the negative electrode plate was wet with diethyl carbonate.

The negative electrode plate was cut so that (i) a first portion of a resultant negative electrode plate, on which first portion a negative electrode active material layer was disposed, had a size of 50 mm×35 mm and (ii) a second portion of the resultant negative electrode plate, on which second portion no negative electrode active material layer was disposed and which second portion had a width of 13 mm, was present around the first portion. The resultant negative electrode plate was used as a negative electrode plate 2.

[Preparation of Nonaqueous Electrolyte Secondary Battery]

The negative electrode plate 2 was used as a negative electrode plate. A nonaqueous electrolyte secondary battery was prepared as in Example 1, except that a laminated separator 3 was used in place of the laminated separator 1. The nonaqueous electrolyte secondary battery thus prepared was referred to as a nonaqueous electrolyte secondary battery 5.

Thereafter, a capacity maintenance rate in the 100th charge-discharge cycle of the nonaqueous electrolyte secondary battery 5 obtained by the above method was measured. Table 1 shows results of measurement.

### Example 6

(Negative Electrode Plate)

A negative electrode plate was obtained which was arranged such that a negative electrode mix (a mixture of artificial spherocrystal graphite, an electrically conductive agent, and PVDF (at a weight ratio of 85:15:7.5)) was disposed on one surface of a negative electrode current collector (copper foil). Confining pressure (0.7 MPa) was applied to the negative electrode plate at a room temperature for 30 seconds in a state where the negative electrode plate was wet with diethyl carbonate.

The negative electrode plate was cut so that (i) a first portion of a resultant negative electrode plate, on which first portion a negative electrode active material layer was disposed, had a size of 50 mm×35 mm and (ii) a second portion of the resultant negative electrode plate, on which second portion no negative electrode active material layer was disposed and which second portion had a width of 13 mm, was present around the first portion. The resultant negative electrode plate was used as a negative electrode plate 3.

[Preparation of Nonaqueous Electrolyte Secondary Battery]

The negative electrode plate 3 was used as a negative electrode plate. A nonaqueous electrolyte secondary battery was prepared as in Example 1, except that a laminated separator 3 was used in place of the laminated separator 1. The nonaqueous electrolyte secondary battery thus prepared was referred to as a nonaqueous electrolyte secondary battery 6.

Thereafter, a capacity maintenance rate in the 100th charge-discharge cycle of the nonaqueous electrolyte secondary battery 6 obtained by the above method was measured. Table 1 shows results of measurement.

### Example 7

[Preparation of Porous Layer and Laminated Separator]

In N-methyl-2-pyrrolidone, a PVDF-based resin (manufactured by Arkema Inc.; product name “Kynar (registered trademark) LBG”; weight-average molecular weight of 590,000) was stirred at 65° C. for 30 minutes and thereby dissolved so that a solid content was 10% by mass. A resultant solution was used as a binder solution. As a filler, alumina fine particles (manufactured by Sumitomo Chemical Co., Ltd.; product name “AKP3000”; containing 5 ppm of silicon) was used. The alumina fine particles, the binder solution, and a solvent (N-methyl-2-pyrrolidone) were mixed together so that the alumina fine particles, the binder solution, and the solvent were in the following proportions. That is, the alumina fine particles, the binder solution, and the solvent were mixed together so that (i) a resultant mixed solution contained 10 parts by weight of the PVDF-based resin with respect to 90 parts by weight of the alumina fine particles and (ii) a solid content concentration (alumina fine particles+PVDF-based resin) of the mixed solution was 10% by weight. A dispersion solution was thus obtained. The dispersion solution was applied as a coating solution by a doctor blade method to a porous film 3, which had been prepared as in Example 3, so that the PVDF-based resin in the coating solution thus applied to the porous film 3 weighed 6.0 g per square meter of the porous film 3. This produced a laminated porous film 4. The laminated porous film 4 was dried at 65° C. for 5 minutes. This produced a laminated separator 4 including the porous film 3 and a porous layer disposed on the porous film 3. A direction of hot air for drying here was arranged to be perpendicular to the laminated porous film 4, and a velocity of the hot air for the drying was set to 0.5 m/s. Table 1 shows results of evaluation of the laminated separator 4.

[Preparation of Nonaqueous Electrolyte Secondary Battery]

A nonaqueous electrolyte secondary battery was prepared as in Example 1, except that the laminated separator 4 was used in place of the laminated separator 1. The nonaqueous electrolyte secondary battery thus prepared was referred to as a nonaqueous electrolyte secondary battery 7.

Thereafter, a capacity maintenance rate in the 100th charge-discharge cycle of the nonaqueous electrolyte secondary battery 7 obtained by the above method was measured. Table 1 shows results of measurement.

### Comparative Example 1

<Preparation of Nonaqueous Electrolyte Secondary Battery Separator>

A porous film 3, to which a coating solution 1 had been applied as in Example 3, was immersed into 2-propanol in a state where a coating film was wet with a solvent, and was then left to stand still at −78° C. for 5 minutes. This produced a laminated porous film 5. The laminated porous film 5 thus obtained was further immersed into the other 2-propanol in a state where the laminated porous film 5 was wet with the above immersion solvent, and was then left to stand still at 25° C. for 5 minutes. This produced a laminated porous film 5a. The laminated porous film 5a thus produced was dried at 30° C. for 5 minutes, so that a laminated separator 5 was obtained. Table 1 shows results of evaluation of the laminated separator 5.

[Preparation of Nonaqueous Electrolyte Secondary Battery]

A nonaqueous electrolyte secondary battery was prepared as in Example 1, except that the laminated separator 5 was used in place of the laminated separator 1. The nonaqueous electrolyte secondary battery thus prepared was referred to as a nonaqueous electrolyte secondary battery 8.

Thereafter, a capacity maintenance rate in the 100th charge-discharge cycle of the nonaqueous electrolyte secondary battery 8 obtained by the above method was measured. Table 1 shows results of measurement.

### Comparative Example 2

(Positive Electrode Plate)

A positive electrode plate was obtained which was arranged such that a positive electrode mix (a mixture of LiNi_{0.5}Mn_{0.3}Co_{0.2}O₂, an electrically conductive agent, and PVDF (at a weight ratio of 92:5:3)) was disposed on one surface of a positive electrode current collector (aluminum foil).

The positive electrode plate was cut so that (i) a first portion of a resultant positive electrode plate, on which first portion a positive electrode active material layer was disposed, had a size of 45 mm×30 mm and (ii) a second portion of the resultant positive electrode plate, on which second portion no positive electrode active material layer was disposed and which second portion had a width of 13 mm, was present around the first portion. The resultant positive electrode plate was used as a positive electrode plate 3.

[Preparation of Nonaqueous Electrolyte Secondary Battery]

The positive electrode plate 3 was used as a positive electrode plate. A nonaqueous electrolyte secondary battery was prepared as in Example 1, except that a laminated separator 3 was used in place of the laminated separator 1. The nonaqueous electrolyte secondary battery thus prepared was referred to as a nonaqueous electrolyte secondary battery 9.

Thereafter, a capacity maintenance rate in the 100th charge-discharge cycle of the nonaqueous electrolyte secondary battery 9 obtained by the above method was measured. Table 1 shows results of measurement.

### Comparative Example 3

(Negative Electrode Plate)

A negative electrode plate was obtained which was arranged such that a negative electrode mix (a mixture of natural graphite, a styrene-1,3-butadiene copolymer, and sodium carboxymethyl cellulose (at a weight ratio of 98:1:1)) was disposed on one surface of a negative electrode current collector (copper foil).

The negative electrode plate was cut so that (i) a first portion of a resultant negative electrode plate, on which first portion a negative electrode active material layer was disposed, had a size of 50 mm×35 mm and (ii) a second portion of the resultant negative electrode plate, on which second portion no negative electrode active material layer was disposed and which second portion had a width of 13 mm, was present around the first portion. The resultant negative electrode plate was used as a negative electrode plate 4.

[Preparation of Nonaqueous Electrolyte Secondary Battery]

The negative electrode plate 4 was used as a negative electrode plate. A nonaqueous electrolyte secondary battery was prepared as in Example 1, except that a laminated separator 3 was used in place of the laminated separator 1. The nonaqueous electrolyte secondary battery thus prepared was referred to as a nonaqueous electrolyte secondary battery 10.

Thereafter, a capacity maintenance rate in the 100th charge-discharge cycle of the nonaqueous electrolyte secondary battery 10 obtained by the above method was measured. Table 1 shows results of measurement.

TABLE 1

| | Laminated separator | | Electrode | | Effect |
|---|---|---|---|---|---|
| | Porous film | | Positive electrode | Negative electrode | Capacity |
| | Temperature | | The number of | The number of | maintenance rate |
| | rise ending | Porous layer | bends before | bends before | in the 100th |
| | time/weight | PVDF | peeling of | peeling of | charge- |
| | per unit area | α ratio | electrode active | electrode active | discharge |
| | (seconds · m²/g) | (mol %) | material layer | material layer | cycle (%) |
| Example 1 | 5.62 | 80.8 | 164 | 1732 | 79.5 |
| Example 2 | 2.99 | 35.3 | 164 | 1732 | 88.1 |
| Example 3 | 5.26 | 44.4 | 164 | 1732 | 74.7 |
| Example 4 | 5.26 | 44.4 | 210 | 1732 | 85.9 |
| Example 5 | 5.26 | 44.4 | 164 | 1858 | 84.3 |
| Example 6 | 5.26 | 44.4 | 164 | 2270 | 80.9 |
| Example 7 | 5.26 | 64.3 | 164 | 1732 | 81.0 |
| Comparative | 5.26 | 34.6 | 164 | 1732 | 60.7 |
| Example 1 | | | | | |
| Comparative | 5.26 | 44.4 | 126 | 1732 | 72.2 |
| Example 2 | | | | | |
| Comparative | 5.26 | 44.4 | 164 | 1633 | 68.0 |
| Example 3 | | | | | |

As is clear from Table 1, the nonaqueous electrolyte secondary batteries prepared in Examples 1 through 7 were more excellent, in capacity maintenance rate in the 100th charge-discharge cycle, than the nonaqueous electrolyte secondary batteries prepared in Comparative Examples 1 through 3.

In other words, it was found that a nonaqueous electrolyte secondary battery can have an improved capacity maintenance rate in the 100th charge-discharge cycle, in a case where the nonaqueous electrolyte secondary battery satisfies the following four requirements: (i) a polyvinylidene fluoride-based resin contained in a porous layer contains an α-form polyvinylidene fluoride-based resin and a β-form polyvinylidene fluoride-based resin, and a content of the α-form polyvinylidene fluoride-based resin is not less than 35.0 mol % with respect to 100 mol % of a total content of the α-form polyvinylidene fluoride-based resin and the β-form polyvinylidene fluoride-based resin in the polyvinylidene fluoride-based resin; (ii) a positive electrode plate is arranged such that the number of bends of the positive electrode plate is not less than 130, the number of bends indicating how many times the positive electrode plate is bent before peeling of a positive electrode active material layer occurs in a folding endurance test according to the MIT tester method specified in JIS P 8115 (1994), the folding endurance test being carried out under conditions of a load of 1 N and a bending angle of 45°; (iii) a negative electrode plate is arranged such that the number of bends of the negative electrode plate is not less than 1650, the number of bends indicating how many times the negative electrode plate is bent before peeling of a negative electrode active material layer occurs in the folding endurance test according to the MIT tester method specified in JIS P 8115 (1994), the folding endurance test being carried out under conditions of a load of 1 N and a bending angle of 45°; and (iv) a porous film has a temperature rise ending time of 2.9 seconds·m²/g to 5.7 seconds·m²/g with respect to a resin content per unit area, in a case where the porous film is impregnated with N-methylpyrrolidone containing 3% by weight of water and is irradiated with a microwave having a frequency of 2455 MHz and an output of 1800 W. That is, the nonaqueous electrolyte secondary battery separator in accordance with an embodiment of the present invention is excellent in capacity maintenance rate after charge-discharge cycles are repeated.

### Reference Example 1

(Positive Electrode Plate)

A positive electrode plate was obtained which was arranged such that a positive electrode mix (a mixture of LiNi_{0.5}Mn_{0.3}Co_{0.2}O₂, an electrically conductive agent, and PVDF (at a weight ratio of 92:5:3)) was disposed on one surface of a positive electrode current collector (aluminum foil). A pressure of 40 MPa was applied to the positive electrode plate at a room temperature with use of a roll press machine. This produced a positive electrode plate A.

(Negative Electrode Plate)

A negative electrode plate was obtained which was arranged such that a negative electrode mix (a mixture of natural graphite having an average particle diameter (D50) of 15 μm based on volume, a styrene-1,3-butadiene copolymer, and sodium carboxymethyl cellulose (at a weight ratio of 98:1:1)) was disposed on one surface of a negative electrode current collector (copper foil). A pressure of 40 MPa was applied to the negative electrode plate at a room temperature with use of a roll press machine. This produced a negative electrode plate A.

The positive electrode plate A and the negative electrode plate A were each subjected to the above-described folding endurance test. As a result, the number of bends of the positive electrode plate A before peeling of a positive electrode active material layer was 64, and the number of bends of the negative electrode plate before peeling of a negative electrode active material layer was 1325.

In other words, it was found that, in a case where an excessive pressure is applied in production of an electrode plate, a resultant electrode plate may not satisfy the above-described requirement for the number of bends.

### INDUSTRIAL APPLICABILITY

A nonaqueous electrolyte secondary battery in accordance with an embodiment of the present invention is excellent in capacity maintenance rate in the 100th charge-discharge cycle. It is therefore possible to suitably use the nonaqueous electrolyte secondary battery in accordance with an embodiment of the present invention as a battery for, for example, a personal computer, a mobile telephone, a portable information terminal, and a vehicle.

1. A nonaqueous electrolyte secondary battery comprising:
a nonaqueous electrolyte secondary battery separator including a polyolefin porous film;
a porous layer containing a polyvinylidene fluoride-based resin;
a positive electrode plate, the number of bends of the positive electrode plate being not less than 130, the number of bends indicating how many times the positive electrode plate is bent before peeling of a positive electrode active material layer occurs in a folding endurance test according to an MIT tester method specified in JIS P 8115 (1994), the folding endurance test being carried out under conditions of a load of 1 N and a bending angle of 45°; and
a negative electrode plate, the number of bends of the negative electrode plate being not less than 1650, the number of bends indicating how many times the negative electrode plate is bent before peeling of a negative electrode active material layer occurs in the folding endurance test,
the polyolefin porous film having a temperature rise ending time of 2.9 seconds·m²/g to 5.7 seconds·m²/g with respect to a resin content per unit area, in a case where the polyolefin porous film is impregnated with N-methylpyrrolidone containing 3% by weight of water and is irradiated with a microwave having a frequency of 2455 MHz and an output of 1800 W,
the porous layer being provided between the nonaqueous electrolyte secondary battery separator and at least one of the positive electrode plate and the negative electrode plate,
the polyvinylidene fluoride-based resin contained in the porous layer containing an α-form polyvinylidene fluoride-based resin and a β-form polyvinylidene fluoride-based resin,
a content of the α-form polyvinylidene fluoride-based resin being not less than 35.0 mol % with respect to 100 mol % of a total content of the α-form polyvinylidene fluoride-based resin and the β-form polyvinylidene fluoride-based resin in the polyvinylidene fluoride-based resin,
the content of the α-form polyvinylidene fluoride-based resin being calculated by (a) waveform separation of (α/2) observed at around −78 ppm in a ¹⁹F-NMR spectrum obtained from the porous layer and (b) waveform separation of {(α/2)+β} observed at around −95 ppm in the ¹⁹F-NMR spectrum obtained from the porous layer.

2. The nonaqueous electrolyte secondary battery as set forth in claim 1, wherein the positive electrode plate contains a transition metal oxide.

3. The nonaqueous electrolyte secondary battery as set forth in claim 1, wherein the negative electrode plate contains graphite.

4. The nonaqueous electrolyte secondary battery as set forth in claim 1, further comprising:
another porous layer which is provided between the nonaqueous electrolyte secondary battery separator and at least one of the positive electrode plate and the negative electrode plate.

5. The nonaqueous electrolyte secondary battery as set forth in claim 4, wherein the another porous layer contains at least one kind of resin selected from the group consisting of polyolefins, (meth)acrylate-based resins, fluorine-containing resins (excluding the polyvinylidene fluoride-based resin), polyamide-based resins, polyester-based resins, and water-soluble polymers.

6. The nonaqueous electrolyte secondary battery as set forth in claim 5, wherein the polyamide-based resins are aramid resins.
